(19) United States
(12) Patent Application Publication
(10) Pub. No.: US 2012/0076286 A1
(43) Pub. Date: Mar. 29, 2012

(54) SYSTEMS AND METHODS FOR INITIATING A TELEPHONE CONFERENCE

(76) Inventors: Michael Tzechan Yie, San Jose, CA (US); Jong Kook An, Sunnyvale, CA (US)

(21) Appl. No.: 12/891,330

(22) Filed: Sep. 27, 2010

(51) Int. Cl. H04M 3/42

(52) U.S. Cl. 379/202.01

(57) ABSTRACT

One example discloses a system for initiating a telephone conference. The system can comprise a memory for storing computer executable instructions and a processing unit for accessing the memory and executing the computer executable instructions. The computer executable instructions can comprise a communication client configured to receive a communication from a network, the communication having a plurality of unique telephone numbers and at least one conference code. The computer executable instructions can also comprise a conference call interface that can be configured to receive a selected telephone number and a selected conference code and to store a memory record in the memory, the memory record having the selected telephone number and the selected conference code. The conference call interface can further be configured to output the selected conference code from the memory record in response to a call to the selected telephone number.

### BACKGROUND

A telephone conference (also known as a conference call) can be a telephone call in which the calling party wishes to have more than one connected party listen in to an audio portion of the call. The telephone conferences can be designed to allow a given connected party to participate during the call, or the call may be set up so that the given connected party merely listens into the call and cannot speak. It is often referred to as an ATC (Audio Tele-Conference).

Many different telephone systems can be employed to connect to a telephone conference. For example, some telephone systems, referred to as smartphones are implemented as a mobile phone that offers advanced computing ability and connectivity. Smartphones are handheld computers integrated within a mobile telephone, which can run applications based on platforms such as Java (e.g., Java, Micro Edition) and/or Binary Runtime Environment (BREW). A smartphone allows a user to install and run advanced applications based on a specific platform. Smartphones run complete operating system software providing a platform for application developers. Moreover, some personal computers (e.g., a microcomputer) can be configured to connect to a telephone conference using voice over Internet Protocol (VoIP).

### BRIEF DESCRIPTION OF THE DRAWINGS

FIG. 1 illustrates an example of a system for initiating a telephone conference.

FIG. 2 illustrates an example of an email client.

FIG. 3 illustrates an example of a conference call interface.

FIG. 4 illustrates an example of a calendar interface.

FIG. 5 illustrates an example of a flow chart of a methodology for initiating a telephone conference.

FIG. 6 illustrates another example of a flow chart of a methodology for initiating a telephone conference.

FIG. 7 illustrates yet another example of a flow chart of a methodology for initiating a telephone conference.

### DETAILED DESCRIPTION

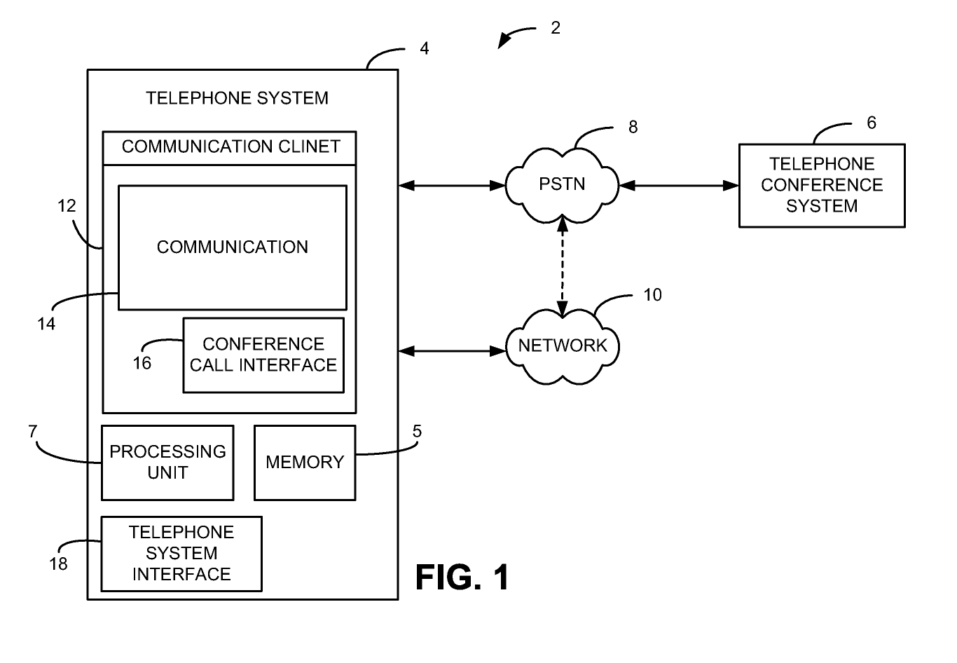

FIG. 1 illustrates an example of a system 2 that can be used to initiate a telephone conference. The system 2 can include a telephone system 4 and a telephone conference system 6 that communicate over the public switched telephone network (PSTN) 8. It is to be understood that unless otherwise noted, use of the term ‘a’ or ‘an’ indicates the presence either singular or plural entities. The telephone system 4 can be implemented, for example as a computer system that can communicate over the PSTN 8 and at least one other network 10, such as the Internet. The telephone system 4 can include for example, a memory 5 for storing data and computer executable instructions. The telephone system 4 can also include a processing unit 7 (e.g., one or more processor cores) that can access the memory 5 and execute the computer executable instructions. The computer executable instructions stored in the memory 5 can be loaded into the memory 5 from a computer readable medium. The computer readable medium could be implemented, for example as a tangible computer readable medium, such as random access memory (RAM), flash memory, a hard disk drive, etc. One of ordinary skill in the art will understand and appreciate the various computer readable mediums that can be used to store the computer executable instructions. It is to be understood that although not shown, the telephone system 4 may communicate with the PSTN 8 via an intermediary system, such as a wireless router, a private telephone network, etc. The telephone system 4 can be implemented, for example as a smartphone, a personal computer, etc. In some examples, the telephone system 4 can communicate with the PSTN 8 through the other network 10 by employing, for example, a voice protocol such as the voice over Internet Protocol (VoIP).

The telephone system 4 can be implemented with a graphical user interface (GUI) that provides human-computer interaction. The telephone system 4 can execute a communication client 12, such as an email client or a message client that can be configured to send and receive communications. The communications can be implemented as email messages, short message service (SMS) messages, which are commonly referred to as text messages, etc. One of ordinary skill in the art will understand and appreciate the various forms in which the communications can be implemented. In an example, one such communication 14 can include a body of text with information relating to a telephone conference, as described herein. Such information might include, for example, a date and time of the telephone conference, at least one a conference code and a plurality of unique telephone numbers.

In one example, each of the plurality of unique telephone numbers can connect to the telephone conference system 6. The telephone conference system 6 can be implemented on a computer system communicating with the PSTN 8. In one example, a conference scheduler (e.g., a user) schedules a telephone conference for a particular time and date on the telephone conference system 6. In such a situation, the telephone conference system 6 provides the conference scheduler with one or more conference codes. The scheduler can provide two or more telephone numbers to one or more invited participants of the telephone conference. At or near the time and date of the conference, one or more of the invited participants can call the telephone conference system 6. Upon connection to the telephone conference system 6, the one or more invited participants input (e.g., dial) a conference code of the one or more conference codes and can be connected to a telephone conference. The participants can thus conduct a telephone conference.

In some environments, the invited telephone conference participants can span large geographic areas. For instance, invited participants can span multiple U.S. States, provinces, countries and/or continents. To accommodate such a situation, the telephone conference system 6 can be configured to connect telephone conference participants that call different telephone numbers. In such a situation, each unique telephone number can be assigned a different conference code that can be associated with the same telephone conference. In other examples, multiple telephone numbers can be associated with the same conference code. Still in other examples, multiple conference codes can be associated with the same phone number. For instance, in one example, a first conference code could be implemented as a conference number; while a second conference code could be implemented as a leader code. Moreover, in such a situation, the conference scheduler can provide the invited participants with the multiple phone numbers and the one or more conference codes.

To invite the telephone conference participants, the conference scheduler can send the multiple telephone numbers to each of the invited participants of the telephone conference via a communication 14. A given invited participant (hereinafter referred to as a user of the telephone system 4) can receive the communication 14 via the communication client 12 executing on the telephone system 4. The communication 14 can include, for example, the time and date of the telephone conference, the multiple telephone numbers for the telephone conference system 6 and the at least one conference code.

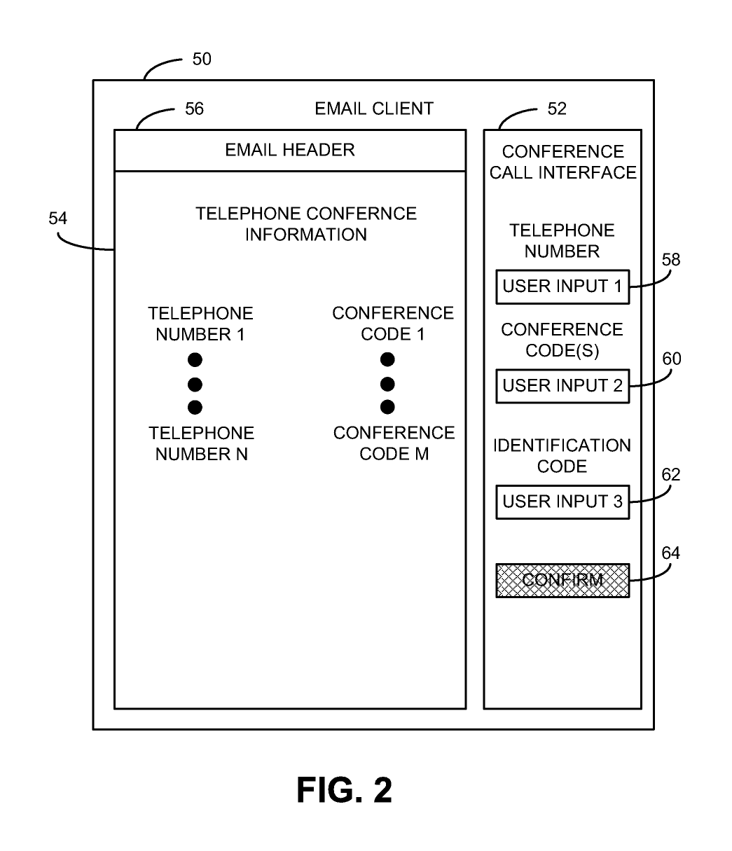

Upon recognizing that the communication 14 is an invitation to participate in a telephone conference, the user of the telephone system 4 can activate a conference call interface 16, which can be implemented as a plug-in of the communication client 12. Additionally or alternatively, the conference call interface 16 can be implemented as a standalone application of the telephone system 4. FIG. 2 illustrates an example of the communication client 12 of FIG. 1 being implemented as an email client 50. As illustrated in FIG. 2, the email client 50 receives the communication 14, wherein the conference call interface 52 has been activated. The conference call interface 52 could be activated, for example by actuation of a virtual button (not shown) in the email client 50, actuation of an icon (not shown) corresponding to the conference call interface 52, etc. One of ordinary skill in the art will understand and appreciate the various methods that the conference call interface 52 could be activated. The email client 50 can be displayed to a user of the telephone system 4 via a GUI.

The email client 50 can display an email message 54, which could be employed to implement the communication 14. The email client 50 could display an email header 56 that could include, for example, the name and/or email address of the sender of the email, the list of recipients of the email message 54 and a subject line of the email message 54.

The email message 54 could include telephone conference information labeled as TELEPHONE CONFERENCE INFORMATION that includes text inviting the user of the smartphone to participate in the telephone conference. The telephone conference information can also include text that identifies the time and date of the telephone conference, as well as the subject matter discussed during the telephone conference. Additionally, the email message 54 can include N number of telephone numbers, labeled as TELEPHONE NUMBER 1 . . . TELEPHONE NUMBER N, where N is an integer greater than or equal to two. Each telephone number can be associated with the telephone conference system illustrated in FIG. 1. Moreover, the email message 54 can also include M number of conference codes labeled as CONFERENCE CODE 1 . . . CONFERENCE CODE M that denotes the conference code or codes for the telephone conference (e.g., conference identification codes, leader codes, etc.), where M is an integer greater than or equal to one.

The conference call interface 52 can be configured to provide a dialog box to the user of the telephone system that allows the user of the telephone system to enter one of the multiple telephone numbers in a USER INPUT 1 field 58. The telephone number can be inputted into the USER INPUT 1 field 58, for example by a copy/cut and paste procedure, wherein the user selects a telephone number from the N number of telephone numbers and highlights the selected telephone number and copies (or cuts) the telephone number into memory, which memory can be referred to as a clipboard. The copied text can be pasted from the clipboard into the USER INPUT 1 field 58. Alternatively, the conference call interface 52 could be configured to include a virtual button, referred to as a telephone number button for automatically inputting the selected telephone number. In such a situation, the telephone number button could be actuated, and the selected telephone number of the multiple telephone numbers could be highlighted, which could trigger the conference call interface 52 to automatically input the selected (and highlighted) telephone number into the USER INPUT 1 field 58. As another alternative example, the conference call interface 52 could be configured to provide an interface that allows the user of the telephone system to “drag and drop” a selected telephone number of the multiple telephone numbers into the USER INPUT 1 field 58. As yet another alternative example, the user can manually enter the selected telephone number into the USER INPUT 1 field 58. In other examples, the N number of telephone numbers and/or the M number of conference codes could be provided in the email message 54 as hyperlinks. In such a situation, the conference call interface 52 could be configured such that USER INPUT 1 field 58 is implemented as a virtual button, wherein upon activation, a dialog box is provided to the user that allows the user to select (e.g., by “clicking”) the selected telephone number of the N number of telephone numbers displayed as hyperlinks. The user can select a conference code from the M number of conference codes and input the selected conference code into a USER INPUT 2 field 60 in a manner similar to the inputting of the selected telephone number.

In some examples, an additional field (not shown) for a second (or more) conference code could be included. In such a situation, the additional field could be employed to input a leader code. In some examples, the conference call interface 52 can provide a USER INPUT 3 field 62 for inputting an identification code to identify the telephone conference. Upon inputting the USER INPUT 1, 2 and 3 fields 58, 60 and 62, the user can actuate a virtual confirmation button 64.

Upon actuation of the virtual confirmation button 64, referring back to FIG. 1, the telephone system 4 can be configured to store a telephone conference record (e.g., a memory record) in a memory 5 of the telephone system 4, such as random access memory (RAM). The telephone conference record can store the data input into the USER INPUT 1, 2 and 3 fields 58, 60 and 62 (illustrated in FIG. 2), thereby storing an association between the selected telephone number, the selected conference code and the identification code or some combination thereof. In some examples, if a telephone conference record already exists in memory 5 that includes the selected telephone number and a different conference code, the conference call interface can be configured to provide a dialog box that prompts the user to overwrite the existing telephone conference record with a new telephone conference record. In other examples, multiple conference codes can be associated with the same telephone number such that multiple telephone conference records with a common telephone number and different conference codes and/or identification codes can be stored in the memory 5.

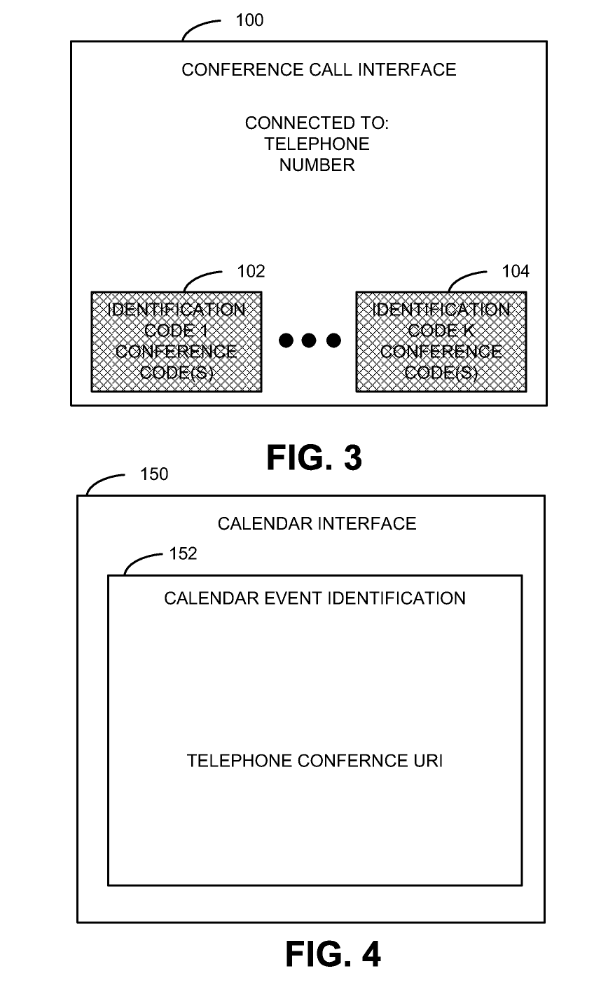

In some examples, the conference call interface 16 can detect if the selected telephone number has been called by the user of the telephone system 4, wherein the telephone number can be entered at a telephone system interface 18 (e.g., a keypad, a keyboard, a touch screen, etc.). Upon detection of calling the selected telephone number, the conference call interface 16 can be configured to provide a dialog box, such as a conference call interface 100 illustrated in FIG. 3.

FIG. 3 illustrates an example of the conference call interface 100 implemented as a dialog box output to a user of the telephone system 4 illustrated in FIG. 1, for example via a GUI, upon the conference call interface 100 detecting that the selected telephone number has been called. In FIG. 3, the conference call interface 100 outputs data stored in one or more telephone conference records. As an example, the output data can include the selected telephone number, labeled as CONNECTED TO: TELEPHONE NUMBER. The conference call interface 100 can also provide K number of virtual buttons referred to as a conference code buttons 102 and 104, where K is an integer greater than or equal to one. Each of the K number of conference code buttons 102 and 104 can output (e.g., as a displayed label) an identification code and one or more associated conference codes included with each stored telephone conference record that includes the selected telephone number. A given conference code button of the K number of conference code buttons 102 and 104 can be configured to initiate an outputting (e.g., dialing) of the one or more conference codes associated with the given conference code button upon actuation of the given conference code button. As an example, upon calling a telephone conference system such as the telephone conference system 6 illustrated in FIG. 1, the telephone conference system 6 can prompt the user of the telephone system 4 illustrated in FIG. 1 to input the conference code. In such a situation, in response to the request, the user of the telephone system 4 can actuate the conference code button 102, thereby providing the telephone conference system 6 with the conference code associated with the conference code button 102. In other examples, separate virtual buttons can be generated for each of the one or more conference codes associated with each identification code. As an alternative, the conference call interface 100 could simply display each identification code and conference code, such that the user could input (e.g., dial) each selected conference code manually.

Referring back to FIG. 1, in some examples, the communication 14 can include an attachment such as a calendar event (also known as a calendar appointment). The calendar event can be stored in calendar software, which calendar software can be implemented as part of the communication client, or as a separate application. Upon determining that the communication 14 includes a calendar event, the user of the telephone system 4 can add the calendar event to the calendar software. Moreover, upon storing the telephone conference record in the memory 5, the conference call interface 16 can be configured to generate a telephone conference uniform resource identifier (URI) that can be provided to the calendar event. The generated URI can include, for example, the selected telephone number, a pause code, one or more selected conference codes, etc. In other examples, the generated URI could include only the selected telephone number. The URI can be implemented to conform to the request for comments (RFC) 3966 standard. As one example, in the event that the selected telephone number is: 555-555-5555 and the selected conference code is 1234, the generated URI could be implemented as: “tel:555-555-5555,,,,1234”, where the commas (‘;’) each denote a pause code. One of ordinary skill in the art will understand and appreciate other URI formats that could be implemented. The URI constitutes an actuatable (e.g., “clickable”) text line that when actuated, can be configured to initiate a call to the selected telephone number. In some examples, the generated URI can also be configured to initiate an outputting (e.g., dialing) of the selected conference code a predetermined amount of time after calling the selected telephone number (e.g., 5-30 seconds).

At a time and date designated by the calendar event, a calendar event interface can be provided to the user of the telephone system 4 via a GUI. FIG. 4 illustrates an example of a calendar interface 150. The calendar interface 150 includes a dialog box displaying a calendar event 152. The calendar event 152 provides an identification of the calendar event, labeled as CALENDAR EVENT IDENTIFICATION. Additionally, the calendar event 152 includes the telephone conference URI, labeled as TELEPHONE CONFERENCE URI. Thus, upon providing the calendar event 152 to the user of the telephone system, the user can actuate the telephone conference URI to initiate a call to the selected telephone number. In examples wherein the telephone conference URI includes the conference code, the conference code can be automatically output after a predetermined amount of time. In examples where the URI does not include the conference code, the conference call interface can be configured to detect the calling of the selected conference call and provide the conference call interface 52 illustrated in FIG. 3.

Referring back to FIG. 1, upon output of the selected telephone number and the selected conference code, the telephone conference system 6 can transfer the user of the telephone system 4 to a telephone conference. Upon the transfer, the user of the telephone system 4 can participate in (and/or listen to) the telephone conference until the telephone conference ends and/or the user of the telephone system 4 elects to disconnect the call to the telephone conference system 6.

By utilizing the system illustrated in FIG. 1, the user of the telephone system 4 can select the telephone number of the multiple telephone numbers that best suits his/her needs. For example, one or more of the telephone numbers can be a local call for a user of the telephone system 4. In such a situation, long distance and/or roaming charges might be avoided by selection of a particular telephone number. In other examples, a particular telephone number may have lower latency, such that the telephone conference will have a higher degree of intelligibility.

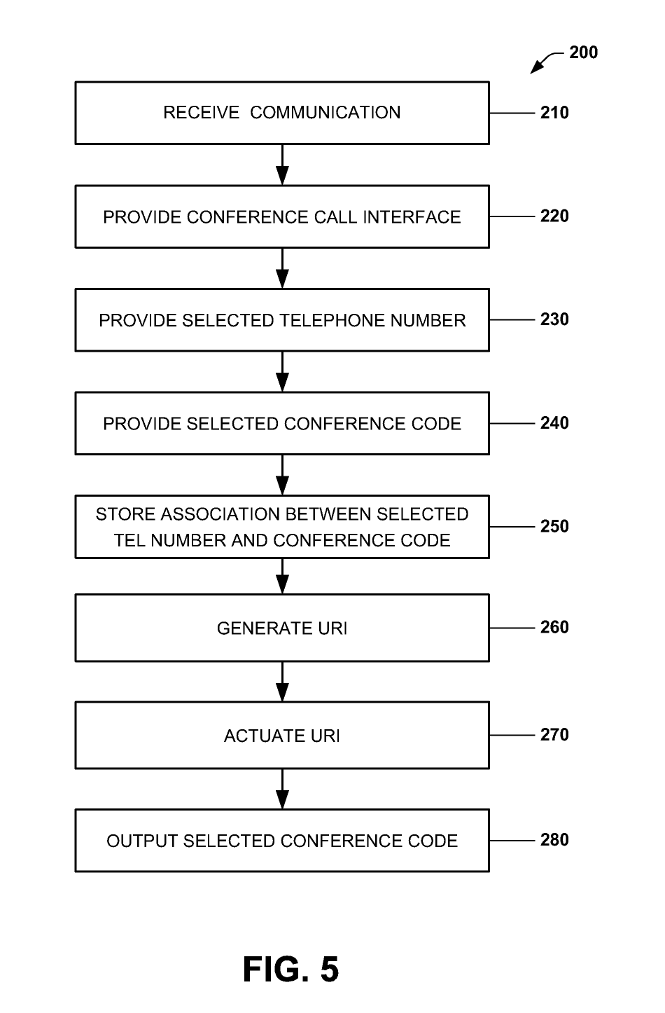

In view of the foregoing structural and functional features described above, example methodologies will be better appreciated with reference to FIGS. 5-7. While, for purposes of simplicity of explanation, the methodologies of FIGS. 5-7 are shown and described as executing serially, it is to be understood and appreciated that the present invention is not limited by the illustrated order, as some actions could in other examples occur in different orders and/or concurrently from that shown and described herein.

FIG. 5 illustrates an example of a flow chart of a methodology 200 for initiating a telephone conference. At 210, a communication is received at a telephone system, such as a smartphone, a computer implemented with VoIP, etc. The communication could be in the form of an email. The communication can contain, for example, a plurality of unique telephone numbers and at least one conference code. At 220 a conference call interface can be provided to a user of the telephone system. The conference call interface can be implemented, for example, as an applet (e.g. a plug-in) or a standalone application on the telephone system.

At 230, a selected telephone number of the plurality of unique telephone numbers in the communication can be provided to the conference call interface. At 240, a selected conference code of the at least one conference codes can be provided to the conference call interface. At 250, the conference call interface can store an association between the selected telephone number and the selected conference code in a memory of the telephone system as a telephone conference record. It is to be understood that a common telephone number can be the selected telephone number in different telephone conference records. In such a situation, the different telephone conference records with a common selected telephone number have differing conference codes and/or identification codes.

At 260, a URI can be generated by the telephone system based on the selected telephone number and the selected conference code. At 270, the URI can be actuated (e.g., selected and/or “clicked”). Actuation of the URI can initiate a call to the selected telephone number. At 280, the selected conference code can be output in response to calling the selected telephone number. In one example, the outputting of the selected conference code can be initiated by the actuation of the URI. In another example, one or more virtual buttons can be provided that initiates the outputting of the selected conference code in response to the virtual button being actuated. In such a situation, each given virtual button of the one or more virtual buttons can be associated with the different telephone conference records that have the selected telephone number.

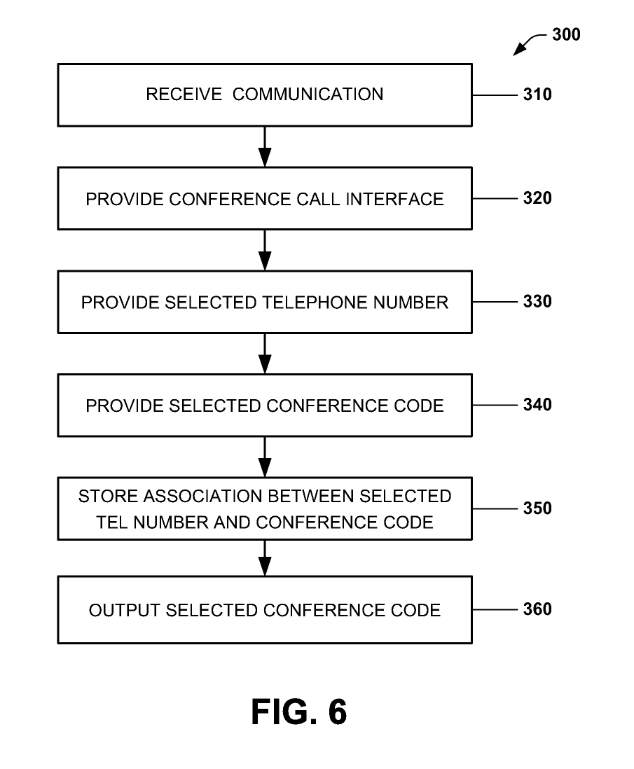

FIG. 6 illustrates another example of a flow chart of a methodology 300 for initiating a telephone conference. At 310, a communication can be received. The communication can have a plurality of unique telephone numbers and at least one conference code. At 320, a conference call interface can be provided to a user. At 330, a selected telephone number of the plurality of unique telephone numbers can be provided to the conference call interface. At 340, a selected conference code of the at least one conference code can be provided to the conference call interface. At 350, an association between the selected telephone number and the selected conference code can be stored in a memory. At 360, the selected conference code can be output from memory in response to a call to the selected telephone number.

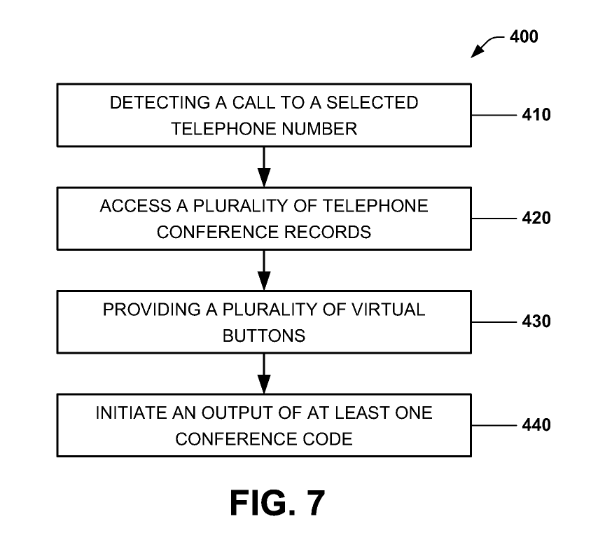

FIG. 7 illustrates yet another example of a flow chart of a methodology 400 for initiating a telephone conference. At 410, a call to a selected telephone number is detected. At 420, a plurality of telephone conference records stored in memory is accessed, wherein each of the plurality of telephone conference records includes the selected telephone number. At 430, a plurality of virtual buttons are provided, wherein a given virtual button of the plurality of virtual buttons is associated with a given telephone conference record of the plurality of telephone conference records. At 440, an output of at least one conference code included in the telephone conference record associated with the given virtual button is initiated in response to actuation of the given virtual button.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the scope of the appended claims.

What is claimed is:

1. A system for initiating a telephone conference comprising:
a memory for storing computer executable instructions;
a processing unit for accessing the memory and executing the computer executable instructions, the computer executable instructions comprising:
a communication client configured to receive a communication from a network, the communication having a plurality of unique telephone numbers and at least one conference code;
a conference call interface configured to:
receive a selected telephone number of the plurality of unique telephone numbers;
receive a selected conference code from the at least one conference code;
store a memory record in the memory, the memory record having the selected telephone number and the selected conference code; and
output the selected conference code from the memory record in response to a call to the selected telephone number.

2. The telephone system of claim 1, wherein the conference call interface is further configured to generate a uniform resource identifier (URI) comprising the selected telephone number for a calendar event.

3. The telephone system of claim 2, wherein the URI further comprises the selected conference code.

4. The telephone system of claim 3, wherein the URI further comprises at least one pause code.

5. The telephone system of claim 1, wherein the conference call interface is further configured to provide a virtual button configured to initiate the outputting of the selected conference code in response to actuation of the virtual button.

6. The telephone system of claim 1, wherein the at least one conference code is one conference code.

7. The telephone system of claim 1, wherein the telephone system is a smartphone.

8. A method for initiating a telephone conference comprising:
receiving a communication having a plurality of unique telephone numbers and at least one conference code;
providing a conference call interface to a user;
providing a selected telephone number of the plurality of unique telephone numbers to the conference call interface;
providing a selected conference code of the at least one conference code to the conference call interface;
storing an association between the selected telephone number and the selected conference code in a memory; and
outputting the selected conference code from memory in response to a call to the selected telephone number.

9. The method of claim 8, further comprising generating a uniform resource identifier (URI) based on the selected telephone number and selected conference code and providing the URI to a calendar event.

10. The method of claim 9, wherein the URI, in response to being actuated, is configured to:
initiate a call to the selected telephone number; and
initiate the outputting of the selected conference code.

11. The method of claim 8, further comprising providing a virtual button that initiates the outputting of the selected conference code in response to actuation of the virtual button.

12. The method of claim 8, wherein the at least one conference code is one conference code.

13. A computer readable medium having computer executable instructions for performing a method for initiating a telephone conference, the method comprising:
detecting a call to a selected telephone number;
accessing a plurality of telephone conference records stored in memory, wherein each of the plurality of the telephone conference records includes the selected telephone number;
providing a plurality of virtual buttons, wherein a given virtual button of the plurality of virtual buttons is associated with a given telephone conference record of the plurality of telephone conference records; and
initiating, in response to actuation of the given virtual button, an outputting of at least one conference code included in the telephone conference record associated with the given virtual button.

14. The computer readable medium of claim 13, wherein the at least one conference code is one conference code.

15. The computer readable medium of claim 13, wherein each of the plurality of virtual buttons is associated with a different telephone conference record of the plurality of telephone conference records.
